(19) United States
(12) Patent Application Publication
(10) Pub. No.: US 2026/0084103 A1
(43) Pub. Date: Mar. 26, 2026

(54) MINIMIZING CORROSION IN PRE-PLASMA ABATEMENT SYSTEMS

(71) Applicant: Applied Materials, Inc., Santa Clara, CA (US)

(72) Inventors: Venugopal VELLANKI, Santa Clara, CA (US); Ju Hyung LEE, Santa Clara, CA (US); Sushim KOSHTI, Portland, OR (US); Ryan T. DOWNEY, San Jose, CA (US)

(21) Appl. No.: 19/309,309

(22) Filed: Aug. 25, 2025

Related U.S. Application Data
(60) Provisional application No. 63/697,238, filed on Sep. 20, 2024.

(51) Int. Cl. B01D 53/32; B01D 53/34; B01D 53/68; B01D 53/76

(52) U.S. Cl. CPC B01D 53/32; B01D 53/346; B01D 53/68; B01D 53/76; B01D 2251/202; B01D 2257/2025; B01D 2257/2027; B01D 2258/0216; B01D 2259/10; B01D 2259/122; B01D 2259/818

(57) ABSTRACT

Embodiments include a method for reducing corrosion in a pump exhaust foreline of a processing system. The method begins with the operation of a plasma processing system and evacuating a fluorine or chlorine containing gas into a processing chamber exhaust foreline as effluent. The effluent is abated in a plasma abatement system with a hydrogen containing reagent in a vacuum environment. The abated effluent contains one or more of HF or HCl at vacuum pressure. A controller runs a program to determine if a condition for condensation of HCl or HF exist based on a characteristic, flow rate and pressure of the effluent. A non-condensable gas is injected into the effluent. The abated effluent is pumped to a pump exhaust foreline coupled to an outlet of the pump, wherein the pump exhaust foreline is at atmospheric pressure.

### CROSS-REFERENCE TO RELATED APPLICATIONS

This application claims priority to the U.S. Provisional Patent Application Ser. No. 63/697,238 filed Sep. 20, 2024 of which is incorporated herein by reference in its entirety.

### BACKGROUND

### Field

Embodiments of the present disclosure generally relate to semiconductor processing equipment. More particularly, embodiments of the present disclosure relate to corrosion minimization in an abatement system.

### Description of the Related Art

The process gases used by semiconductor processing facilities include many compounds, such as perfluorocarbons (PFCs), which must be abated or treated before disposal, due to regulatory requirements and environmental and safety concerns. Typically, a remote plasma source may be coupled to a processing chamber to abate the compounds exiting the processing chamber. A reagent may be injected into the plasma source to assist the abatement of the compounds.

Conventional abatement technology for abating PFCs utilizes water vapor as a reagent, which provides good destruction removal efficiency (DRE). However, abatement of certain compounds using water vapor in the remote plasma source can result in the corrosion of equipment downstream of the remote plasma source, such as exhaust line and pumps, if the pressure in the line rises above a threshold for condensation. The condensation contains acid which ultimately results in corrosion.

Accordingly, what is needed in the art is an improved abatement system for abating compounds produced in semiconductor processes.

### SUMMARY

Embodiments include a processing system configured to reduce corrosion in a pump exhaust foreline. The processing system includes a processing chamber having a chamber exhaust. A processing chamber exhaust foreline is fluidly coupled to the chamber exhaust and configured to evacuate the processing chamber of unwanted gases as effluent. An abatement reactor is coupled to the processing chamber exhaust foreline wherein the abatement reactor energizes the effluent and introduces a hydrogen containing gas to change the characteristics of the effluent. An abatement exhaust foreline is fluidly coupled to the abatement reactor and operable to receive the effluent. A pump is fluidly coupled to the abatement exhaust foreline and configured to move the effluent from the processing chamber, wherein the pump places the processing chamber exhaust foreline, plasma abatement system and abatement exhaust foreline in a vacuum pressure environment. A pump exhaust foreline is coupled to an outlet of the pump, wherein the downstream foreline is at atmospheric pressure. A foreline gas source is configured to inject a non-condensable gas into the pump exhaust foreline. A controller is coupled to the processing system, plasma abatement system, downstream meter, and foreline gas source for operating the processing system and configured to reduce corrosion in the pump exhaust foreline.

In another embodiment, a method for reducing corrosion in a pump exhaust foreline of a processing system. The method begins with the operation of a plasma processing system and evacuating a fluorine or chlorine containing gas into a processing chamber exhaust foreline as effluent. The effluent is abated in a plasma abatement system with a hydrogen containing reagent in a vacuum environment. The abated effluent contains one or more of HF or HCl at vacuum pressure. A controller runs a program to determine if a condition for condensation of HCl or HF exist based on a characteristic, flow rate and pressure of the effluent. A non-condensable gas is injected into the effluent. The abated effluent is pumped to a pump exhaust foreline coupled to an outlet of the pump, wherein the pump exhaust foreline is at atmospheric pressure.

In another embodiment, a computer-readable storage medium storing a program, which, when executed by a processor performs an operation for reducing corrosion in a plasma abatement system. The operation begins with the operation of a plasma processing system and evacuating a fluorine or chlorine containing gas into a processing chamber exhaust foreline as effluent. The effluent is abated in a plasma abatement system with a hydrogen containing reagent in a vacuum environment. The abated effluent contains one or more of HF or HCl at vacuum pressure. A controller runs a program to determine if a condition for condensation of HCl or HF exist based on a characteristic, flow rate and pressure of the effluent. A non-condensable gas is injected into the effluent. The abated effluent is pumped to a pump exhaust foreline coupled to an outlet of the pump, wherein the pump exhaust foreline is at atmospheric pressure.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 is a schematic side view of a vacuum processing system including a vacuum processing chamber coupled to an abatement system according to one embodiment described herein.

FIG. 2 illustrates a process flow for reducing corrosion in a plasma abatement system.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments disclosed herein include an abatement system for abating compounds produced in semiconductor processes, and methods for operating the same. The abatement system includes a device for regulating the flow of a non-condensable gas into an effluent treated by the abatement system. The non-condensable gas may be injected into the effluent flowing in an abatement exhaust foreline prior to a vacuum pump. Alternately, the non-condensable gas may be injected into the vacuum pump. In another alternative, the non-condensable gas may be injected into the effluent flowing in a pump exhaust foreline fluidly coupled to an outlet of the vacuum pump. A pressure guage may monitor the pressure of the flow within the abatement exhaust foreline, the pump exhaust foreline, or the pump, and upon determining that the flow has dropped below a threshold, an alarm may be activated or additional non-condensable gas may be injected into the effluent flow. The additional non-condensable gas flow reduces acid condensation in the pump exhaust foreline, which ultimately results in less corrosion and longer service life. Thus, the abatement system can be maintained and operated more cost effectively over a longer duration.

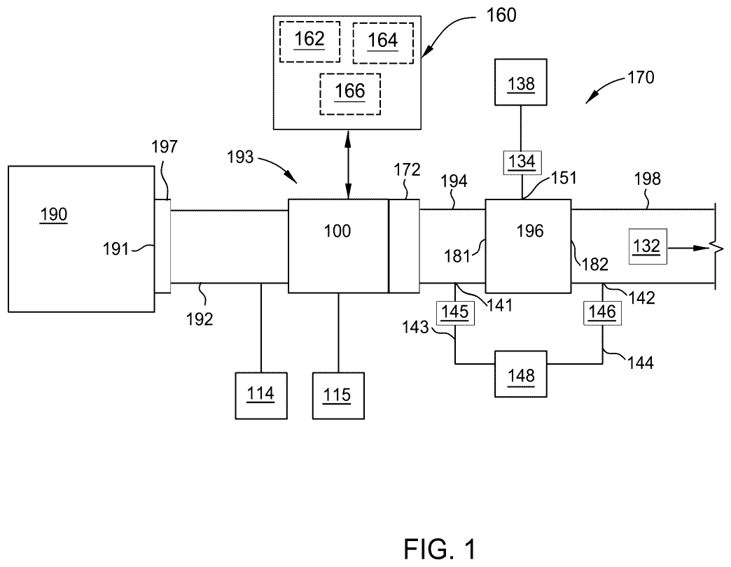

FIG. 1 is a schematic side view of a vacuum processing system 170 having vacuum processing chamber 190 fluidly coupled to an abatement system 193. The vacuum processing system 170 includes at least one vacuum processing chamber 190 coupled to an abatement system 193 having an abatement reactor 100. The abatement system 193 may optionally have a particle collection trap 172.

The vacuum processing chamber 190 is generally configured to perform at least one integrated circuit manufacturing process, such as a deposition process, an etch process, a plasma treatment process, a preclean process, an ion implant process, or other integrated circuit manufacturing process. The process performed in the vacuum processing chamber 190 may be plasma assisted. For example, the process performed in the vacuum processing chamber 190 may be a plasma deposition process for depositing a material on a substrate or a plasma etch process for removing a material from a substrate. During processing and cleaning, gasses are introduced into the vacuum processing chamber. Certain operations, such as deposition or etch, have gases ionized to form a plasma for processing a substrate in a vacuum environment. For example, the vacuum processing chamber 190 may maintain a pressure of about 0.5 Torr to about 500 Torr, such as about 3 Torr to about 80 Torr, such as about 3 Torr to about 60 Torr, such as about 3 Torr to about 50 Torr, such as about 3 Torr to about 40 Torr, or such as about 3 Torr to about 5 Torr during processing.

The gases used in the vacuum processing chamber 190, and their byproducts, create potent and long lasting gases which may be dangerous to humans and/or the environment. For example, one or more process gasses may contain fluorine or chlorine which combine with other gases or byproducts to form a fluorinated gas or chlorinated gas which is evacuated from the vacuum processing chamber 190 as effluent to stop processing and reduce chamber contamination and/or substrate defects.

The vacuum processing chamber 190 has a chamber exhaust port 191. The vacuum processing chamber 190 is coupled through the exhaust port 191 to a processing chamber exhaust foreline 192. The chamber exhaust port 191 may optionally be coupled to a turbo pump 197. The effluent is moved from the vacuum processing chamber 190 into the processing chamber exhaust foreline 192. The effluent in the processing chamber exhaust foreline 192 remains at a low vacuum pressure such as below 500 Torr.

The abatement reactor 100 of the abatement system 193 is fluidly coupled to the vacuum processing chamber 190 by the processing chamber exhaust foreline 192. In one example, the abatement reactor 100 may be a plasma abatement reactor. In another example, the abatement reactor 100 may be a thermal abatement reactor. The abatement reactor 100 breaks down the effluent into less dangerous or more easily disposed of chemicals. Hydrogen base reagents may be added to the foreline 192 or the abatement reactor 100 to aid in breaking down the effluent into chemicals which may be further processed or disposed. The reagents may include hydrogen (H₂), ammonia (NH₃), methane (CH₄) water (H₂O) or other suitable hydrogen containing gas. In one example, the hydrogen based reagent is water, H₂O. After abatement by the abatement reactor 100, the effluent may contain hydrogen fluoride (HF) and/or hydrogen chloride (HCl).

The optional particle collection trap 172 may be located downstream of the abatement reactor 100 in order to collect particles formed in the abatement reactor 100 and to cool the exhaust exiting the abatement reactor 100. The particle collection trap 172 may be directly coupled to the abatement reactor 100. Alternately, a conduit may couple the particle collection trap 172 to the abatement reactor 100.

An abatement exhaust foreline 194 is fluidly coupled to a downstream side of the abatement reactor 100. Alternately, the abatement exhaust foreline 194 is fluidly coupled to a downstream side of the particle collection trap 172. The first fluid conduit is fluidly coupled to a rough pump 196.

The pump 196 has an inlet 181 and an outlet 182. The pump 196 pulls the effluent from the vacuum processing chamber 190 through the abatement system 193 into the inlet 181 of the pump 196. The pump 196 may be a vacuum pump or rough pump. The pump 196 operates in a vacuum range having a pressure less than approximately 1×10⁻³ Torr. In one example, pump 196 is a rough pump suitable for working in the vacuum range. As such, the pump 196 pulls a vacuum from the vacuum processing chamber 190, through the abatement system 193, to the inlet 181 in the pump 196. For example, the pump 196 may maintain a vacuum on the abatement system 193 of around 10⁻³ Torr upstream of the pump 196, i.e., between the abatement reactor 100 and the inlet 181 of the pump 196.

The outlet 182 of the pump 196 is fluidly coupled to a pump exhaust foreline 198. The pump exhaust foreline 198 receives the treated effluent from the abatement system 193 via the pump 196. The treated effluent in the pump exhaust foreline 198 is at a pressure of about 1 (atm) atmospheric pressure, i.e., 760 Torr. Thus, the treated effluent may go from a vacuum pressure of about 10⁻³ Torr in the abatement exhaust foreline 194 to atmospheric pressure of about 760 Torr in the pump exhaust foreline 198. In some examples, where the effluent contains a fluorinated gas, the hydrogen based reagents create gaseous hydrogen fluoride (HF) which dissolves in water to yield an aqueous hydrofluoric acid. In other examples, where the effluent contains a chlorinated gas, the chlorine based reagents create gaseous hydrogen chloride (HCl) which dissolves in water to yield an aqueous hydrochloric acid. The hydrofluoric acid, and more so the hydrochloric acid, are corrosive to the pump exhaust foreline 198. To prevent the acid condensation in the pump exhaust foreline 198, nitrogen, argon, helium, oxygen or other suitable anticorrosion or non-condensable gas may be provided at a suitable rate. The non-condensable gas defines gases which condense below the temperatures and at greater pressures than required to condense hydrogen fluoride or hydrogen chloride. Additionally, non-condensable gas is relatively insoluble in liquid hydrogen fluoride or hydrogen chloride. Such gases include silicon tetrafluoride, nitrogen, hydrogen, oxygen, the inert and rare gases and the like. Risk of acid corrosion in the abatement exhaust foreline 194 is low because the abatement exhaust foreline 194 is at a vacuum pressure from the pump 196. However, it has been found that monitoring the effluent and/or an anticorrosion gas flow into the abatement exhaust foreline 194, the pump 196 or the pump exhaust foreline 198 may be suitable to mitigate the risk of acid condensation in the pump exhaust foreline 198. For example, the control of the anticorrosion gas flow, such as a non-condensable N₂, may be based on the reagent flow, for example, H₂O, to prevent corrosion in the pump exhaust foreline 198. A downstream meter 132 may operate to determine the pressure in the pump exhaust foreline 198.

A pump purge gas source 138 may be fluidly coupled by a gas line to the pump 196 at a first pump location 151. A pump flow meter 134 disposed on the gas line. The pump flow meter 134 may monitor the amount of gas from the pump purge gas source 138 entering into the pump 196. Optionally, the pump flow meter 134 may contain a valve and regulate the amount of gas from the pump purge gas source 138 entering into the pump 196. In one example, the pump purge gas source 138 may provide an inert gas for cleaning or purging the pump 196. The pump purge gas source 138 may supply nitrogen or other suitable gas into the pump 196. In one example, the pump purge gas source 138 provides nitrogen gas into the pump 196. The pump purge gas source 138 may additionally be monitored with the pump flow meter 134 to operate in a manner to prevent corrosion in the pump exhaust foreline 198. For example, a non-condensable gas may be supplied to the pump 196 in sufficient quantities to at the first pump location 151 to dilute the effluent and prevent the formation of condensation of the HF or HCl in the pump exhaust foreline 198.

In another example, non-condensable gas is introduced in the exhaust conduit 194 upstream of the inlet 181 of the pump 196. A foreline gas source 148 may be fluidly coupled by a first line 143 to provide the non-condensable gas at a first location 141 in the abatement exhaust foreline 194. Optionally, a first flow meter 145 may be disposed on the first line 143. The first flow meter 145 may monitor the amount of gas from the foreline gas source 148 entering into the abatement exhaust foreline 194. Optionally, the first flow meter 145 may contain a valve and regulate the amount of gas from the foreline gas source 148 entering into abatement exhaust foreline 194. The foreline gas source 148 may provide nitrogen, argon, helium, oxygen or other suitable non-condensable gas at a determined rate into the abatement exhaust foreline 194 for preventing the HF effluent from condensing in the pump exhaust foreline 198. The non-condensable gas is supplied by the foreline gas source 148 in sufficient quantity to dilute the HF or HCl in the effluent from condensing and corroding the pump exhaust foreline 198.

In yet another example, non-condensable gas is introduced in the pump exhaust foreline 198 downstream of the outlet 182 of the pump 196. The foreline gas source 148 may be fluidly coupled by a second line 144 to provide the non-condensable gas at a second location 142 in the pump exhaust foreline 198. Optionally, a second flow meter 146 may be disposed on the second line 144. The second flow meter 146 may monitor the amount of gas exiting from the foreline gas source 148 and entering into the pump exhaust foreline 198. Optionally, the second flow meter 146 may contain a valve and regulate the amount of gas exiting from the foreline gas source 148 and entering into the pump exhaust foreline 198. The foreline gas source 148 may provide nitrogen, argon, helium, oxygen or other suitable non-condensable gas at a determined rate into the pump exhaust foreline 198 for preventing the HF effluent from condensing in the pump exhaust foreline 198. The non-condensable gas is supplied by the foreline gas source 148 in sufficient quantity to dilute the HF or HCl in the effluent from condensing and corroding the foreline gas source 148.

It should be noted that the prior examples for providing the non-condensable gas in one of the first location 141, the second location 142 or the pump location 143 for preventing condensation in the pump exhaust foreline 198 may be performed in the alternative or in conjunction with providing non-condensable gas in one or more other of the first location 141, the second location 142 or the pump location 143. That is, a method may operate wherein the non-condensable gas is provided to only one of the first location 141, the second location 142 or the pump location 143, the method may operate wherein the non-condensable gas is provided to two or all three of the first location 141, the second location 142 or the pump location 143.

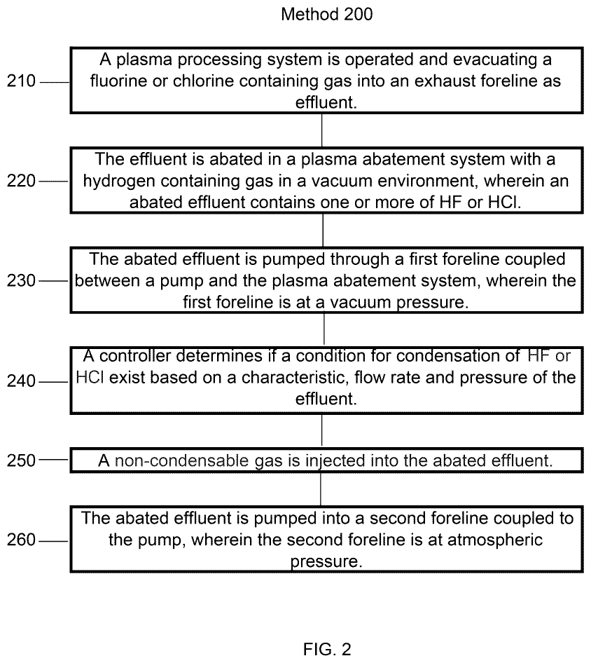

A system controller 160 is coupled to the vacuum processing system 170 for controlling the vacuum processing chamber 190, the abatement system 193, pump 196 and/or gas sources, for example, foreline gas source 148 or pump purge gas source 138. For example, the system controller 160 may be in communication with the pump flow meter 134, the first flow meter 145, the second flow meter 146 the and/or downstream meter 132, and control the operations of the pump purge gas source 138, and/or foreline gas source 148. In operation, the system controller 160 enables a process flow 200 illustrated in FIG. 2 for mitigating the formation of corrosive agents in the pump exhaust foreline 198.

The system controller 160 generally includes a central processing unit (CPU) 162, memory 164, and support circuits 166. The CPU 162 may be one of any form of a general purpose processor that can be used in an industrial setting. The memory 164, non-transitory computer-readable medium, or machine-readable storage device, is accessible by the CPU 162 and may be one or more of memory such as random access memory (RAM), read only memory (ROM), floppy disk, hard disk, or any other form of digital storage, local or remote. The support circuits 166 are coupled to the CPU 162 and may comprise cache, clock circuits, input/output subsystems, power supplies, and the like. The system controller 160 is configured to perform the process flow 200 stored in the memory 164. The various implementations disclosed in this disclosure may generally be implemented under the control of the CPU 162 by executing computer instruction code stored in the memory 164 (or in memory of a particular process chamber) as, e.g., a computer program product or software routine. That is, the computer program product is tangibly embodied on the memory 164 (or non-transitory computer-readable medium or machine-readable storage device). When the computer instruction code is executed by the CPU 162, the CPU 162 controls the instructions to the gas sources for controlling corrosion in the pump exhaust foreline 198 described below in accordance with the various implementations.

FIG. 2 illustrates a process flow for reducing corrosion in a plasma abatement system. The process flow 200 begins at operation 210 wherein a plasma processing system is operated and a process gas continuing fluorine or chlorine is evacuated as waste into a processing chamber exhaust foreline as effluent. For example, the plasma processing system may perform an etch operation or a clean operation utilizing chlorine or fluorine gas as one of the gasses in the plasma processing chamber. The chlorine or fluorine gas is extremely reactive and may bond to other metals, metalloids, reactive nonmetals or other elements. For example, fluorine (F2), composed of two fluorine atoms, combines with all other elements except helium and neon to form ionic or covalent fluorides. The waste gas containing the chlorine or fluorine ions is removed from the processing chamber as effluent. In one example, a pump may evacuate the processing chamber of the waste chlorine or fluorine into the processing chamber exhaust foreline for abatement.

At operation 220, the effluent is abated in an abatement system with a hydrogen containing gas in a vacuum environment. The effluent remains at a vacuum pressure of less than approximately 1×10⁻³ Torr. The abatement reactor of the abatement system is fluidly coupled to the vacuum processing chamber by the processing chamber foreline. In one example, the abatement reactor is a plasma abatement reactor. In another example, the abatement reactor is a thermal abatement reactor. A reagent is introduced in to the abatement reactor for abating the effluent. The reagent may include hydrogen (H₂), ammonia (NH₃), methane (CH₄) water (H₂O) or other suitable hydrogen containing gas. The abated fluorine or chlorine in the effluent bonds with the hydrogen from the reagent to form hydrogen fluoride (HF) or hydrogen chloride (HCl) in the effluent.

At operation 230, the abated effluent is pumped through an abatement exhaust foreline fluidly coupled to a downstream side of the abatement reactor. The abatement exhaust foreline is coupled between a pump and the plasma abatement system. The abatement exhaust foreline is maintained at a vacuum pressure.

At operation 240, a controller determines if a condition for condensation of hydrogen fluoride or hydrogen chloride exists based on a characteristic, flow rate and pressure of the effluent at the abatement exhaust foreline or a pump exhaust foreline. For example, the controller may determine from the process recipe in the plasma processing system if fluorine or chlorine gas was present. Furthermore, the controller may determine if hydrogen was used in the treatment of the fluorine or chlorine gas and a concentration of HCl or HF is present in the treated effluent. The controller may determine the amount and flow rate of HCl or HF in the pump exhaust foreline at atmospheric pressure. The controller may determine if the conditions exist for hydrogen fluoride or hydrogen chloride to condensate out of the effluent when the effluent goes from a vacuum condition in the abatement exhaust foreline to atmospheric pressure in the pump exhaust foreline.

At operation 250, a non-condensable gas is injected into the abated effluent. The non-condensable gas is relatively insoluble in liquid hydrogen fluoride or hydrogen chloride. The non-condensable gas condense below the temperatures and at greater pressures than required to condense hydrogen fluoride (HF) or hydrogen chloride (HCl), thus preventing the formation of an acid. Such non-condensable gases include silicon tetrafluoride, nitrogen, hydrogen, oxygen, the inert and rare gases and the like. The non-condensable gas may be supplied in sufficient to dilute the effluent and prevent the formation of condensation of the HF or HCl in the pump exhaust foreline. The controller determines if conditions exist for hydrogen fluoride or hydrogen chloride to condensate out of the effluent exist. The controller then determines an amount of non-condensable gas to be injected into the abated effluent to prevent the condensation from occurring. In one example, the non-condensable gas is nitrogen.

In one example, the non-condensable gas is provided from a gas source into the effluent at a first location in the abatement exhaust foreline. The abatement exhaust foreline being at a vacuum pressure. Optionally, a first flow meter may monitor the amount of non-condensable gas from the gas source entering into the abatement exhaust foreline. Optionally, a valve may be used to regulate the amount of non-condensable gas from the gas source entering into abatement exhaust foreline. This example provides for easy distribution of the non-condensable gas as the environment is at a vacuum pressure. Additionally, the non-condensable gas dilutes the HF or HCl prior to entering the pump for extending the life of the pump.

In another example, the non-condensable gas is provided from the gas source into the effluent flowing inside the pump. The non-condensable gas is injected into the effluent at a second location in the pump. Optionally, a second flow meter may monitor the amount of non-condensable gas from the gas source entering into the pump. Optionally, a valve may be used to regulate the amount of non-condensable gas from the gas source entering into pump. This example additionally provides for purging the pump.

In yet another example, the non-condensable gas is provided from the gas source into the pump exhaust foreline. The pump exhaust foreline is at an atmospheric pressure. The non-condensable gas is injected into a second location in the pump exhaust foreline. Optionally, a second flow meter may monitor the amount of non-condensable gas from the gas source entering into the pump exhaust foreline. Optionally, a valve may be used to regulate the amount of non-condensable gas from the gas source entering into pump exhaust foreline. This example provides for precise control of the dilution of the HF or HCl with the non-condensable gas to ensure no condensation occurs in the pump exhaust foreline.

At operation 260, the abated effluent is pumped into pump exhaust foreline coupled to the outlet of the pump, wherein the pump exhaust foreline is at atmospheric pressure. The abated effluent may have the non-condensable gas added prior to entering the pump exhaust foreline. Alternately, the abated effluent may have the non-condensable gas added after entering the pump exhaust foreline.

The pump exhaust foreline may have a downstream flow meter for monitoring a flow of the effluent in the pump exhaust foreline. The downstream flow meter is coupled to the controller for providing effluent flow and pressure information. In response to monitoring the flow of the effluent, the controller may adjust the flow of non-condensable gas to a desired level for preventing condensation in the pump exhaust foreline.

Advantageously, with the system and method described above, significant corrosion can be avoided in the pump exhaust foreline of an abatement system. The method utilizes monitors to detect the conditions for condensation and adjusts the flow of non-condensable gases to minimize the cost of the used gases. This in effect extends the time between service for the exhaust system as well as gas bottle changeover which reduces production downtime and lowers the total cost of production.

While the foregoing is directed to embodiments of the present disclosure, other and further embodiments of the disclosure may be devised without departing from the basic scope thereof, and the scope thereof is determined by the claims that follow.

What is claimed is:

1. A plasma abatement system comprising:
an abatement exhaust foreline configured to be fluidly coupled in-line between an abatement reactor and a pump, the abatement exhaust foreline operable to receive effluent from the abatement reactor;
a sensor configured to measure a pressure of the effluent in the abatement exhaust foreline;
a foreline gas source configured to inject a non-condensable gas into the abatement exhaust foreline; and
a controller coupled to the sensor and the foreline gas source, the controller operable configured to inject the non-condensable gas from the foreline gas source into the abatement exhaust foreline based on determining pressure information received by the controller from the sensor exceeding a threshold.

2. The plasma abatement system of claim 1, wherein the non-condensable gas provided by the foreline gas source includes nitrogen, argon, helium, and/or oxygen.

3. The plasma abatement system of claim 1 further comprising:
a processing chamber exhaust foreline fluidly coupled to the abatement reactor, wherein the abatement reactor energizes the effluent from the processing chamber exhaust foreline in presence of a hydrogen containing gas;
a pump fluidly coupled to the abatement exhaust foreline, the pump is configured to move the effluent from the processing chamber exhaust foreline, the pump is operable to create a vacuum pressure environment in the processing chamber exhaust foreline, plasma abatement system and abatement exhaust foreline;
a pump exhaust foreline coupled to an outlet of the pump; and
a downstream meter disposed in the pump exhaust foreline and configured to measure a pressure of material in the pump exhaust foreline.

4. The plasma abatement system of claim 3, wherein the foreline gas source is further configured to inject the non-condensable gas into the pump exhaust foreline.

5. The plasma abatement system of claim 4, a pump gas source fluidly coupled through a flow meter to the pump, wherein the flow meter is configured to meter an amount of the non-condensable gas provided by the pump gas source into the pump.

6. A method of reducing corrosion in a pump exhaust foreline of a processing system, the method comprising:
operating a plasma processing system and evacuating a fluorine or chlorine containing gas as effluent into a processing chamber exhaust foreline;
abating the effluent in a plasma abatement system with a hydrogen based reagent in a vacuum environment, wherein an abated effluent contains one or more of hydrogen fluoride (HF) or hydrogen chloride (HCl);
pumping the abated effluent through an abatement exhaust foreline coupled between a pump and the plasma abatement system, wherein the abatement exhaust foreline is at a vacuum pressure;
determining with a controller if a condition for condensation of HF or HCl exist based on a characteristic, flow rate and pressure of the effluent;
providing instructions to inject a non-condensable gas into the abated effluent upon determining a condition for condensation may exist; and
pumping the abated effluent into a pump exhaust foreline coupled to the pump, wherein the pump exhaust foreline is at atmospheric pressure.

7. The method of claim 6, wherein the non-condensable gas is one or more of nitrogen, argon, helium, and oxygen.

8. The method of claim 7, wherein the non-condensable gas is injected into the pump exhaust foreline.

9. The method of claim 7, wherein the non-condensable gas is injected into the abatement exhaust foreline.

10. The method of claim 6, wherein the pump may maintain a vacuum on the plasma abatement system of around 10⁻³ Torr upstream of the pump in the abatement exhaust foreline.

11. The method of claim 6, wherein the hydrogen based reagent may include hydrogen (H₂), ammonia (NH₃), methane (CH₄), and water (H₂O).

12. The method of claim 6 further comprising:
monitoring a flow of the effluent in the pump exhaust foreline with a downstream flow meter; and
in response to monitoring the flow of the effluent, adjusting the flow of non-condensable gas to a desired level.

13. The method of claim 9 further comprising:
adjusting a flow of non-condensable gas based on the effluent.

14. The method of claim 6 further comprising:
monitoring a flow of the non-condensable gas entering the pump with a pump flow meter; and
in response to monitoring the flow of the non-condensable gas and the effluent type from the plasma abatement system, adjusting the flow of non-condensable gas to a desired level.

15. A computer-readable storage medium storing a program, which, when executed by a processor performs an operation for reducing corrosion in a plasma abatement system, the operation comprising:
operating a plasma processing system and evacuating a fluorine or chlorine containing gas into an exhaust foreline as effluent;
abating the effluent in a plasma abatement system with a hydrogen containing gas in a vacuum environment, wherein an abated effluent contains one or more of hydrogen fluoride (HF) or hydrogen chloride (HCl);
pumping the abated effluent through an abatement exhaust foreline coupled between a pump and the plasma abatement system, wherein the abatement exhaust foreline is at a vacuum pressure;
determining with a controller if a condition for condensation of HF or HCl exist based on a characteristic, flow rate and pressure of the effluent;
injecting a non-condensable gas into the abated effluent; and
pumping the abated effluent into a pump exhaust foreline coupled to the pump, wherein the pump exhaust foreline is at atmospheric pressure.

16. The computer-readable storage medium storing the program of claim 15, wherein the non-condensable gas is one or more of nitrogen, argon, helium, and oxygen, and wherein the non-condensable gas is injected into the pump exhaust foreline.

17. The computer-readable storage medium storing the program of claim 16, wherein the pump may maintain a vacuum on the plasma abatement system of around 10⁻³ Torr upstream of the pump in the abatement exhaust foreline.

18. The computer-readable storage medium storing the program of claim 15 further comprising:
monitoring a flow of the effluent in the pump exhaust foreline with a downstream flow meter; and
in response to monitoring the flow of the effluent, adjusting the flow of non-condensable gas to a desired level.

19. The computer-readable storage medium storing the program of claim 18 further comprising:
adjusting the flow of non-condensable gas based on the effluent.

20. The computer-readable storage medium storing the program of claim 15 further comprising:
monitoring a flow of the non-condensable gas entering the pump with a pump flow meter; and
in response to monitoring the flow of the non-condensable gas and the effluent type from the plasma abatement system, adjusting the flow of non-condensable gas to a desired level.
